(19) United States
(12) Patent Application Publication
(10) Pub. No.: US 2006/0180434 A1
(43) Pub. Date: Aug. 17, 2006

(54) Tray positioning device for stacking of product and method of use

(76) Inventors: Thomas A. Arnold, Owego, NY (US); Michael E. Caporali, Endicott, NY (US); Eric Reisenauer, Owego, NY (US); John T. Swider, Port Crane, NY (US)

Correspondence Address: MCGUIREWOODS, LLP, 1750 TYSONS BLVD, SUITE 1800, MCLEAN, VA, 22102, US

(21) Appl. No.: 11/058,178

(22) Filed: Feb. 16, 2005

(51) Int. Cl. B65G 47/22

(52) U.S. Cl. 198/463.3; 198/345.1

(57) ABSTRACT

A system and method designed to position a tray. The system includes a conveyor pivotable between a first position and a incline position and a tray carriage in a tray transportation path with the conveyor. The tray carriage is moveable between an elevated, horizontal position and a lowered position when the conveyor is in the first position and the substantially vertical position, respectively.

### FIELD OF THE INVENTION

The invention generally relates to a tray positioning device and method of use and, more particularly, to a tray positioning device to stack product in a tray in either a horizontal orientation or vertical orientation and method of use.

### BACKGROUND DESCRIPTION

The sorting of mail is a very complex, time consuming task. In general, the sorting of mail is processed through many stages, including back end processes, which stack mail pieces in a tub or container in delivery order sequence. These processes can either be manual or automated, depending on the mail sorting facility, the type of mail to be sorted such as packages, flats, letters and the like. A host of other factors may also contribute to the automation of the mail sorting, from budgetary concerns to modernization initiatives to access to appropriate technologies to a host of other factors.

In general, however, most modern facilities have taken major steps toward automation by the implementation of a number of technologies. These technologies include, amongst others, letter sorters, parcel sorters, advanced tray conveyors, flat sorters, stacking devices and the like. As a result of these developments, postal facilities have become quite automated over the years, considerably reducing overhead costs and increasing mail throughput.

By way of example, in front end processes, sorting and sequencing systems are capable of sequencing mail pieces and other product based on a two pass algorithm system. Of course, other known systems can equally be used to sort mail pieces and other product, a host of them readily available and known to those of ordinary skill in the art. As the mail pieces are ejected from the system, after being sorted or sequenced, they may be manually placed into a container. However, this manual process is very time consuming, costly and error prone.

In some applications, the mail pieces may be fed automatically into a tray or tub. However, these known systems are designed only to place the mail pieces in one orientation and thus do not exhibit the flexibility needed by the ever evolving requirements of the United States Postal System (USPS). For example, in one known device, the mail pieces or other product are unloaded to containers located at each drop off point, via chutes. In this manner, the mail pieces are slid down the chutes into the containers and are stacked within the containers in a horizontal orientation.

Although these horizontal automation systems have provided many benefits, they still lack the required flexibility to stack product in a vertical orientation, a requirement that may become essential by the ever increasing demands of the USPS e.g., both horizontal and vertical stacking. In fact, there is no known single machine that is capable of meeting such requirements of the USPS. Thus, currently known systems cannot provide the required design flexibility to enhance the productivity and overall evolving efficiencies demanded by the postal system and other customers.

The invention is directed to overcoming one or more of the problems as set forth above.

### SUMMARY OF THE INVENTION

In accordance with a first aspect of the invention, a system for positioning a tray includes a conveyor pivotable between a first position and a substantially vertical position and a tray carriage in a tray transportation path with the conveyor. The tray carriage is moveable between an elevated, horizontal position and a lowered position when the conveyor is in the first position and the substantially vertical position, respectively.

In accordance with another aspect of the invention, a system for stacking product in a horizontal orientation or a vertical orientation includes a conveyor pivotable between a horizontal position and a substantially vertical position and a tray carriage moveable between a nested position with the conveyor and a raised, horizontal position. At least one stop mechanism is provided for registering a tray positioned on the tray carriage or a portion of the conveyor.

In another aspect of the invention, a method is provided for stacking product in either a horizontal orientation or a vertical orientation. The method may equally be employed on computer medium as a control. The method includes determining whether product is to be stacked in the horizontal orientation or the vertical orientation. If stacking is to be in the horizontal orientation, the method includes:
elevating a tray into a raised, horizontal position;
inducting the product into the tray; and
lowering the tray when the product within the tray meets a predetermined criteria.

If stacking is to be in the vertical orientation, the method includes:
rotating a tray into a raised, substantially vertical position;
inducting product into the tray; and
lowering the tray when the product within the tray meets the predetermined criteria.

### BRIEF DESCRIPTION OF THE DRAWINGS

The foregoing and other aspects and advantages will be better understood from the following detailed description of embodiments of the invention with reference to the drawings, in which:

FIG. 1 shows a tray positioning device in accordance with the invention;

FIG. 2 shows a cut-away view of FIG. 1 along line A-A in accordance with the invention;

FIG. 3 shows the tray positioning device during a horizontal stacking mode;

FIG. 4 shows the tray positioning device during an operational stage of the vertical stacking mode;

FIG. 5 shows the tray positioning device during an operational stage of the vertical stacking mode; and

FIG. 6 is a flow diagram of the methods of one exemplary embodiment of the invention.

### DETAILED DESCRIPTION OF EMBODIMENTS OF THE INVENTION

The invention is directed to a tray positioning device designed to orient a tray for stacking product therein in either a vertical orientation or a horizontal orientation. The product may be, for example, flats and other mail items (i.e., letters), for future delivery or warehousing or the like. The invention significantly reduces machine costs by allowing a single machine to stack product in delivery point sequence, in embodiments, in a vertical orientation or a horizontal orientation. Other applications such as warehousing and storage applications are also contemplated for use with the invention.

In one aspect of the invention, the system contains two degrees of freedom in motion:
(i) Pivoting a conveyor, which sets a vertical height and orientation of the tray for vertical stacking mode operations. In this mode, the system of the invention allows stacking of product in a vertical orientation; and
(ii) Raising a tray carriage to a delivery belt which sets a height and orientation of the tray for horizontal stacking mode operations.

In this mode, the system of the invention allows stacking of product in a horizontal orientation, for example.

The positioning device can easily be switched between modes and is transparent to the surrounding automation. The positioning device may be modular, and thus can be retrofitted to the back end systems of known sequencing systems, without affecting the sorting and sequencing operations.

For both horizontal and vertical stacking of product, the tray is indexed onto a conveyor system, and held stationary by a stop or other mechanism. The tray is lifted to a height of a delivery belt for induction of product into the tray, in either a horizontal or vertical orientation. In either orientation, the tray will preferably remain at a same or substantially same angle as a conveying frame. Additionally, features of the invention are designed to ensure that the tray remains substantially stationary, will not topple or rotate, and that the product remains within the tray during processing.

### Tray Positioning System of the Invention

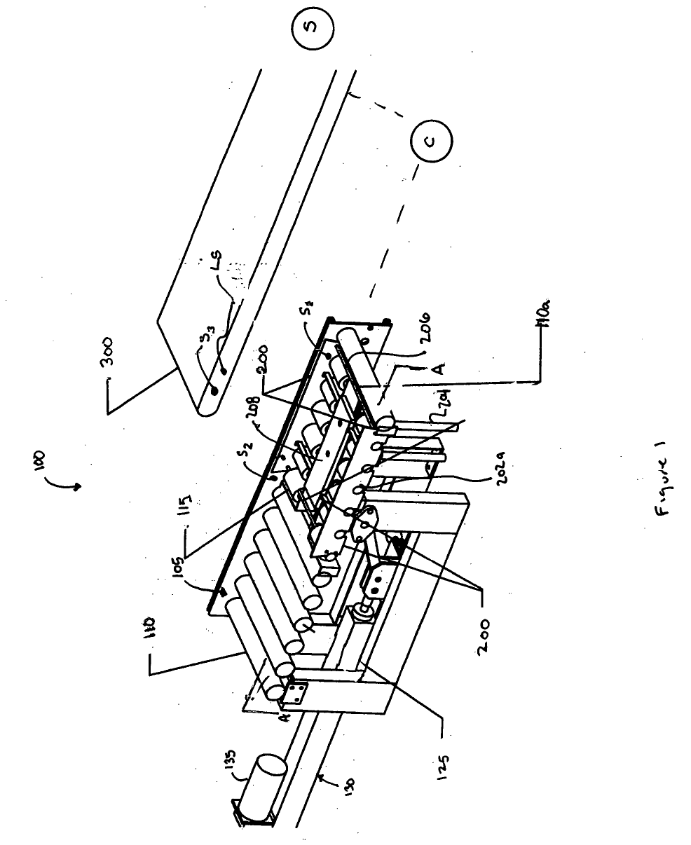

Referring now to FIG. 1, a diagram of the tray positioning device is shown. In the embodiment of FIG. 1, the tray positioning device is generally depicted as reference numeral 100 and includes a conveyor 105 having power rollers 110 and a tray carriage 200. In one aspect of the invention, segmented rollers 115 are located at the tray carriage 200 and a single power roller 110a is positioned at an exit of the tray carriage 200. A separate delivery belt 300 is positioned proximate to the tray positioning device 100 and, in embodiments, is positioned at a predetermined height above the tray positioning device 100. A sorting or sequencing machine “S” is in the feed path of the delivery belt 300 such that product can be inducted onto the delivery belt 300 and transported to a tray.

The tray positioning device 100 further includes a frame member 125. The frame member 125 is preferably a module frame member which is capable of being retrofitted to any known tray conveyor system or sequencing device, as a back end system. An actuator assembly 130 is mounted to the frame 125 and is designed, upon energizing a motor 135, to raise the conveyor 105 into a substantially vertical orientation. The motor 135 may be a stepper motor or linear motor, for example, having a reversible operation. The vertical orientation of the conveyor 105 may be approximately 60° to 70° from the horizontal; although, other angles are also contemplated by invention.

Still referring to FIG. 1, the tray carriage 200 includes opposing side plates 202, each having a plurality of notches 202a which align with ends or axles of the segmented rollers 115. By having the notches, in one implementation, the tray carriage 200 can be positioned or located below a contacting or transporting surface of the segmented rollers 115 in order to allow a tray to be indexed thereon (as discussed more fully below) when the carriage is in the lowered position. This allows the tray carriage 200 to be nested or recessed within the conveyor 105 and thus will not interfere with movement of the tray when in the lowered position. The tray carriage 200 further includes a mechanism 204 for lifting and lowering the tray carriage 200 between a raised position and a lowered position, respectively. The mechanism 204 may be an air cylinder, linear actuator, rack and pinion gear, hydraulic lift, or other lifting and lowering device, all generally depicted as reference numeral 204.

A front stop mechanism 206 such as, for example, a rod, knob or other mechanism, extends above a supporting surface 208 of the tray carriage 200. In the lowered position of the tray carriage 200, the stop mechanism 206 is preferably positioned below a contacting or transporting surface of the segmented rollers 115 and the single power roller 110a. This positioning ensures that the tray can be removed from the tray carriage 200, when the tray is filled and the tray carriage 200 is in the lowered position.

The front stop mechanism 206, being at a height higher than the supporting surface, will ensure, amongst other features, that the tray is properly registered or positioned on the tray carriage 200 and securely positioned on the tray carriage 200 when lifted into a raised, horizontal position. In addition, the height of the front stop mechanism 206 allows the power rollers to remain energized during the placement of the tray onto the tray carriage 200. In this latter operational stage, the stop mechanism 206 will ensure the proper registration of the tray within the tray carriage 200, and will prevent the tray from exiting the tray carriage 200 during loading operations.

In one aspect of the invention, several sensors are provided in communication with a controller “C”. By way of illustration, a sensor S₁ such as a photodiode is provided proximate to the stop mechanism 206. Additionally, a photodiode S₂ or other type of sensor may be positioned near an intake portion of the tray carriage 200, with a photodiode S₃ positioned at approximately the level of the tray in a raised position. A limit switch “LS”, encoder other type of sensor may also be used to determine the height of the tray carriage 200, when in the raised position.

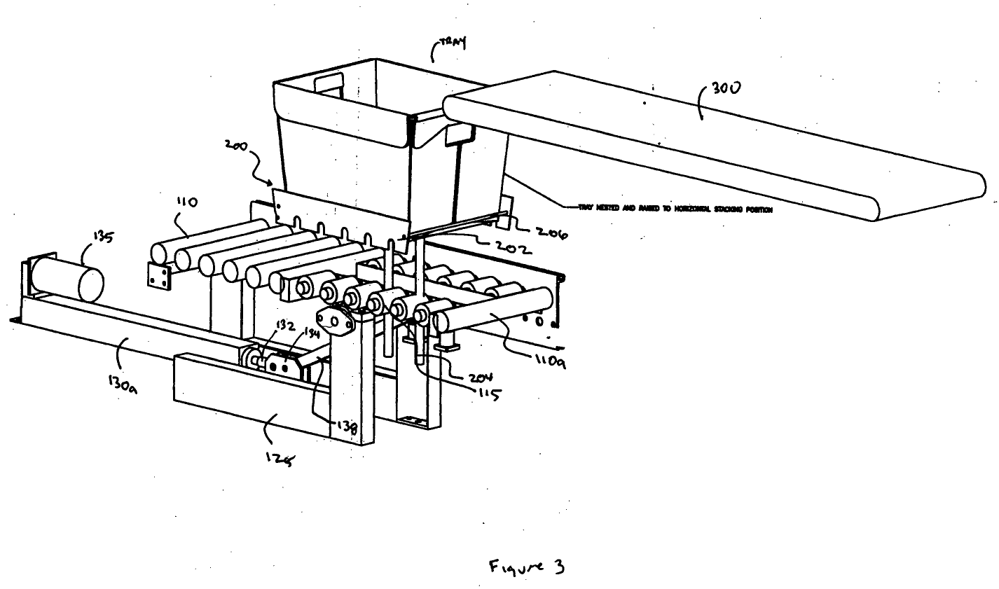

In implementation, the sensors provide information to the controller “C” in order to coordinate movement of the tray carriage 200, conveyor 105, and delivery belt 300 and, in embodiments, related components. For example, using a photodiode or proximity sensor SI, a determination can be made as to when the tray is properly registered or seated within the tray carriage 200, during a horizontal stacking mode operation. As should be well understood by those of skill in the art, the photodiode SI will transmit a beam of light, for example, between a transmitter and receiver. When this beam is broken by the tray, a signal may be sent to the controller “C” which, in turn, will instruct movement of the tray carriage 200 into the raised position (FIG. 3).

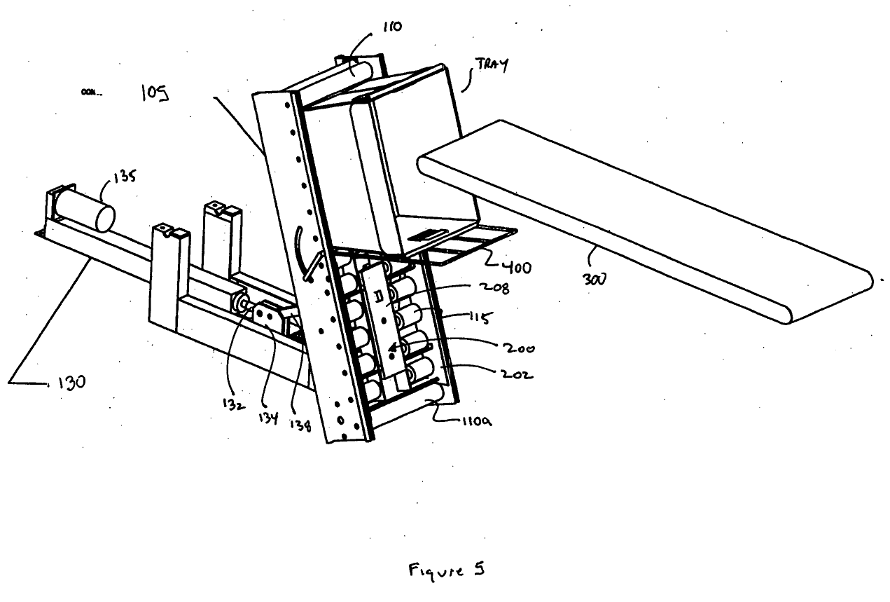

Similarly, during a vertical stacking mode operation, the photodiode or proximity sensor S2 or other type of sensor, positioned near an intake portion of the tray carriage 200, will sense the position of the tray at such location. When the tray is in the proper position, a signal may be sent to the controller “C” which, in turn, will instruct movement of the conveyor 105 into the raised, vertical position (FIG. 5). The limit sensor or encoder LS may be used to determine the height or angle of the tray positioning device 100 when in the raised position, in either the horizontal or the vertical stacking mode.

The photodiode S₃ or a weight sensor can be used to determine when the tray is filled with product. Alternatively, a thickness measurement device (also depicted as S₃) may be used to measure the thickness of the product prior induction into the tray. In either example, once it is determined that the tray is fill, in either the horizontal or vertical stacking mode, the tray will be lowered, and the power rollers will be energized to remove the tray from the tray positioning device 100. In particular, in the vertical stacking mode, the power rollers 110, segmented rollers 115 and power roller 110a will be energized to transport the tray through the tray carriage 200 and ejected from the conveyor 105. In the horizontal stacking mode, it may not be necessary to energize the power rollers 110, since the tray has already been transported past this section of the tray positioning device 100.

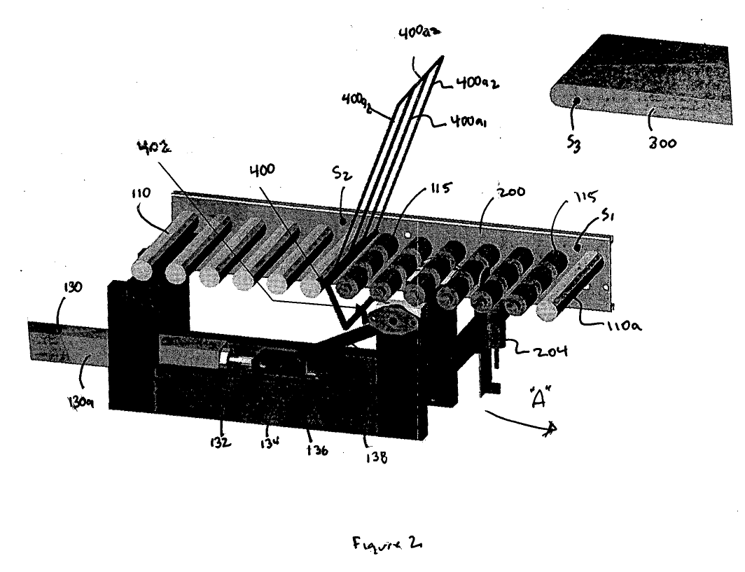

FIG. 2 shows a cut-away section along A-A of FIG. 1. This figure more clearly shows the actuator assembly 130 and the lifting mechanism 204, in addition to a rotating support plate or bar 400. The actuator assembly 130 includes an extending rod 132 slidable within a housing 130a of the actuator assembly 130. The extending rod 132 is mounted to a bracket 134 (or housing) which acts as a hub, for example. The bracket 134 is, in turn, mounted to a truck 136 or other rolling-type or moveable platform, generally referred to as a carriage. An arm or shaft 138 is mounted between the bracket 134 and an underside of the conveyor 105, preferably near the tray carriage 200. When the motor 135 is energized, the extending rod 123 will extend from the actuator housing 130a, moving the carriage 136 in the direction of arrow “A”. This, in turn, will raise the conveyor 105 into the vertical position, via the movement of the arm 138 (FIG. 5). Upon reversal of the motor 135, the extending rod 132 will retract within the actuator housing 130a and result in the system returning to its original position (FIG. 1).

Still referring to FIG. 2, in the vertical stacking mode, rotating support plate or bar 400 will be raised and lowered by a conventional mechanism such as, for example, an air cylinder, linear actuator, rack and pinion gear, hydraulic lift, or other lifting and lowering device, all generally depicted as reference numeral 402. In one illustrative embodiment, the rotating support plate or bar 400 includes an upper section 400a having inner rails 400a₁ which are designed to be seated or nested within spaces between the segmented rollers 115 (when in the lowered position) and outermost rails 400a₂ designed to be seated or nested within the space between the segmented rollers and the side plates 202. This arrangement ensures that the support plate or bar 400 does not interfere with the operations of the rollers during the transportation of the tray. In one aspect, a lower section 400b of the support plate or bar 400 is provided at a slight angle to better effectuate the rotation of the support plate or bar 400 by the mechanism 402.

FIG. 3 shows the tray in a raised position during a horizontal stacking mode. In this illustration, the lifting mechanism 204 raises the tray carriage into the upper position such that the open portion of the tray is at a substantially same level as the delivery belt 300. In one implementation, the upper edge of the tray is slightly below the delivery belt. As shown, the stop bar 206 of the tray carriage 200 is slightly raised above the supporting surface and contacts a leading edge of the tray such that the tray cannot tumble forward. In the horizontal stacking mode, the support plate or bar 400 is lowered and recessed within portions of the system. In this, configuration, the bar 400 will not interfere with movement of the tray onto the tray carriage 200.

During the loading of the tray onto the tray carriage 200, the tray carriage 200 may be slightly raised such that the stop mechanism 206 is positioned above the power roller 110a. In this slightly raised position, the stop mechanism 206 will block the tray from contacting the power roller 110a and thus prevent the tray from exiting the tray carriage 200. Also, in this slightly raised position, the stop mechanism 206 will also assist in the proper registration and alignment of the tray within the tray carriage 200. That is, the stop mechanism 206 will allow the power rollers 110 to remain energized, pushing the tray onto the tray carriage while ensuring that the tray will move only to the stop mechanism, which is in a loading position alignment.

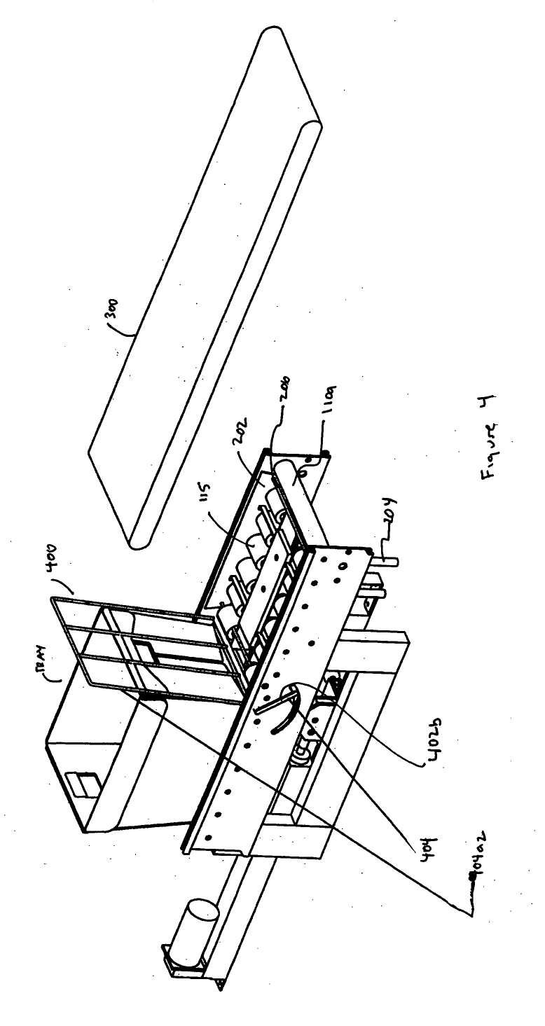

FIG. 4 shows an operational stage of the system when in the vertical stacking mode. In this operational stage, the support plate or bar 400 is rotated into the raised position. An arcuate slot 404 is located within the side panel 202 and engages with the outermost rails of the lower portion 400b of the support plate or bar 400. The arcuate slot 404 acts as a guide and limiting mechanism for the rotation of the support plate or bar 400. In one aspect of the invention, the power rollers are powered down or switched off when the support plate or bar 400 is in the rotated, raised position.

FIG. 5 shows another operational stage of the system during the vertical stacking mode. In this operational stage, the motor 135 is energized and the conveyor 105 is rotated into a substantially vertical position. The raised support plate or bar 400 will prevent the tray from moving during this vertical operational stage, in addition to acting as a back stop for any product that extends outside of the tray; that is, the support plate or bar 400 will prevent the product from “flopping” over an edge of the tray during the induction of the product into the tray.

### Method of using the System of the Invention

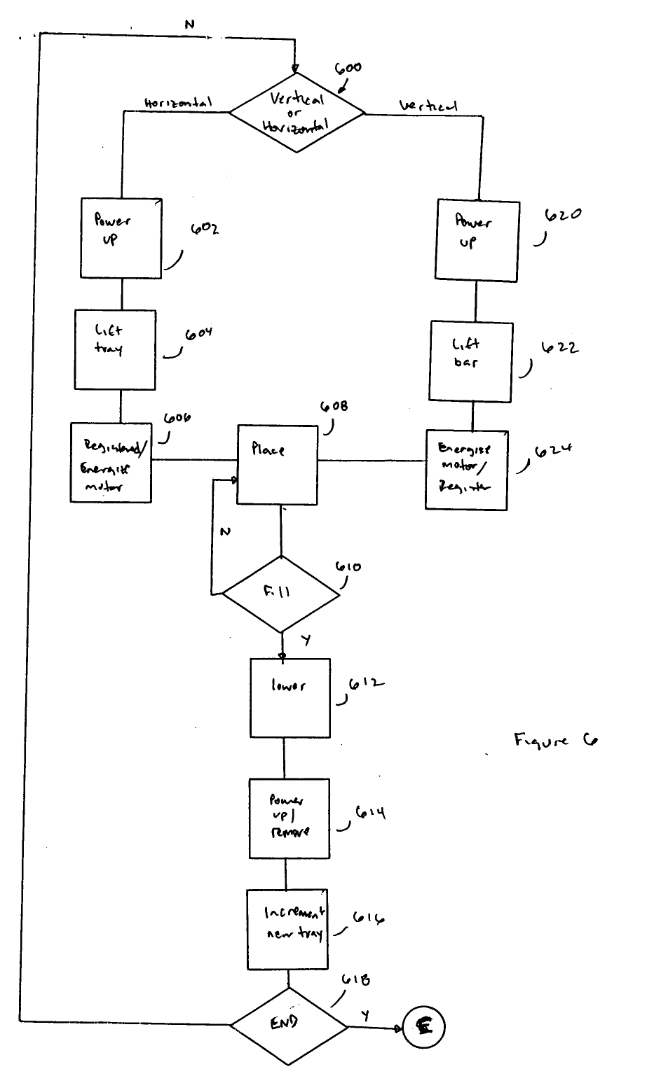

FIG. 6 is a flow chart showing the operational commands and steps of the invention. FIG. 6 may equally represent a flow showing the steps of implementing the method of the invention. The steps of the invention may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM).

The system of the invention may be used for a single carrier route at a time, multiple routes at once or for warehousing or other sequencing needs of products. Also, some or all of the different operational stages shown in FIG. 6 may be coordinated by the controller “C”, and performed synchronously or asynchronously with two or more of the systems described herein. Also, some of the steps disclosed herein may be interchanged with one another, and no order should be implied.

At step 600, a determination is made as to whether the system is in the horizontal stacking mode or the vertical stacking mode. In the horizontal stacking mode, the power rollers are energized in order to increment a tray onto the tray carriage, at step 602. Synchronously with the operational stage of step 602, the tray carriage may begin to slightly rise, approximately ¾ of an inch in one contemplated embodiment (step 604). This will allow the tray to be properly registered on the tray carriage. Once the tray is properly registered or positioned on the tray carriage, as may be determined by the sensor S₁, the tray carriage will be raised to an appropriate height (step 606) consistent with the loading of product therein (FIG. 3). The encoder, stepper motor or sensor may sense when the tray is at the proper height.

At step 608, product is placed within the tray, via the delivery belt or other delivery system such as a shoot, in preferably a sequenced order. In one implementation, the activation of the delivery belt is coordinated with the position of the tray carriage (raised position in the horizontal stacking mode) or the rotation of the conveyor (vertical rotation in the vertical stacking mode). This will ensure that the movement of the product is properly coordinated with the position of the tray prior to placement of the product therein. At step 610, a determination is made as to whether the tray is filled to a predetermined height or weight, using sensor S₃. If the tray is not filled, steps 608 and 610 are repeated. Once the tray is determined to be filled to a predetermined height or weight (or no further product is available), the tray carriage is lowered, at step 612. (In the vertical stacking mode, the conveyor is rotated to the lowered position at step 612.)

Once the system is in the lowered position, the rollers are again energized to remove the tray from the conveyor, at step 614. A new tray may be incremented onto the conveyor, segmented rollers, at step 616. At step 618, a determination is made as to whether further product needs to be stacked within a tray or if further product is available. If no further product is available or required to be stacked into the tray, the operation ends at “E”. If, however, further product is to be stacked, the operations may return to step 600. In one embodiment, the operation may return to either step 602 or 620, if the operational mode is already known.

In the vertical stacking position, at step 620, the power rollers are energized in order to transport the tray to the vertical stacking position (FIG. 4). The bar is lifted and the rollers are powered down at steps 622 and 624. The actuator motor may be energized to rotate the conveyor into the vertical position (FIG. 5). Once in the vertical position, the steps 608-618 may be processed by the system of the invention.

While the invention has been described in terms of embodiments, those skilled in the art will recognize that the invention can be practiced with modification within the spirit and scope of the appended claims.

It is claimed:

1. A system for positioning a tray, comprising:
a conveyor pivotable between a first position and an incline position; and
a tray carriage in a tray transportation path with the conveyor, the tray carriage being moveable between an elevated, position and a lowered position.

2. The system of claim 1, further comprising a first mechanism to move the conveyor to the first position and the incline position and a second mechanism to move the tray carriage to the elevated position and the lowered position, the elevated position being a substantially horizontal elevated position.

3. The system of claim 1, wherein:
the tray carriage includes a supporting surface and a raised stop mechanism proximate an ejection region of the tray carriage;
the supporting surface and the raised stop mechanism are nested below a transporting surface of the conveyor when the tray carriage is in the lowered position; and
the raised stop mechanism prevents a tray from being ejected from the tray carriage when the tray carriage begins to be raised or is in the elevated position.

4. The system of claim 3, wherein the tray carriage further comprises side walls and forms a frame with the supporting surface and the raised stop mechanism to hold a tray on the tray carriage when in the elevated position.

5. The system of claim 3, further comprising:
a first sensor to determine a registration of a tray on the tray carriage; and
at least a second sensor to determine at least one of:
when the tray carriage is in the elevated position to stop movement thereof, and
a full tray load condition to stop induction of product therein.

6. The system of claim 1, wherein the vertical position is approximately 60 degrees to 70 degrees with respect to a horizontal supporting surface.

7. The system of claim 1, wherein:
the tray carriage, when in the lowered position, is nested within portions of the conveyor; and
the tray carriage is positioned below a transporting surface of the conveyor when the tray carriage is nested.

8. The system of claim 1, further comprising a stop bar rotatable between a raised position and a nested position, wherein
when in the nested position, the stop bar is recessed within a portion of the conveyor,
when in the raised position and the conveyor is in the incline position, the stop bar maintains a tray in the vertical position.

9. The system of claim 1, further comprising a controller coordinating:
movement of the conveyor to the incline position when a stop bar is in a raised position;
movement of the conveyor to the first position when a tray is filled to a predetermined height or weight;
movement of the tray carriage to the elevated position when a tray is registered on the tray carriage and the conveyor is in the first position; and
ejection of the tray from the conveyor or the tray carriage when the conveyor is lowered to the first position and the tray carriage is in the lowered position.

10. The system of claim 1, further comprising:
a first actuator assembly for raising the conveyor to the incline position and lowering the conveyor to the lowered position, comprising:
a carriage;
a rod mounted to the carriage;
an arm mounted to the carriage and an underside of the conveyor; and
a motor energizable to extend the rod and move the carriage and arm in a first direction to raise the conveyor; and
a second actuator assembly for raising and lowering the tray carriage between the elevated position and the lowered position.

11. The system of claim 1, wherein:
the tray carriage is moveable into the elevated position when the conveyor is in the first position; and
the tray carriage remains in the lowered position when the conveyor is in the incline position.

12. The system of claim 1, further comprising:
a delivery belt for induction of product to a tray; and
a controller coordinating movement of product into the tray from the delivery belt when the tray carriage is in the elevated position or the conveyor is in the incline position.

13. A system for stacking product in a tray in either a horizontal orientation or a vertical orientation, comprising:
a conveyor pivotable from a first position to an incline position to stack the product in the vertical orientation in the tray;
a tray carriage moveable from a nested position with respect to the conveyor to a raised, horizontal position to stack the product in the horizontal orientation in the tray; and
at least one stop mechanism for registering the tray on the tray carriage or a portion of the conveyor.

14. The system of claim 13, wherein:
the at least one stop mechanism is a first stop mechanism and a second stop mechanism;
the first stop mechanism:
is located at an ejection region of the tray carriage;
is at a height above a supporting surface of the tray carriage;
is nested below a transporting surface of the conveyor when the tray carriage is in the nested position; and
prevents the tray from exiting the tray carriage when the tray carriage is beginning to be raised or is in the raised, horizontal position; and
the second stop mechanism:
is rotatable between a raised position and a nested position; and
is a recessed within a portion of the conveyor when in the nested position.

15. The system of claim 13, further comprising:
a first device to determine a registration of the tray on the tray carriage; and
at least a second device to determine at least one of:
when the tray carriage is in the raised, horizontal position to stop movement thereof; and
a full tray load condition to stop induction of product therein.

16. The system of claim 13, further comprising a controller to coordinate any of:
movement of the conveyor to the incline position when a stop bar is in a raised position;
movement of the conveyor to the first position or the tray carriage to the nested position when a tray is filled to a predetermined height or weight;
movement of the tray carriage to the elevated, horizontal position when a tray is registered on the tray carriage and the conveyor is in the first position; and
ejection of the tray from the conveyor or the tray carriage when the conveyor is lowered to the first position and the tray carriage is in the nested position.

17. The system of claim 13, further comprising:
a first actuator assembly for raising the conveyor to the incline position and lowering the conveyor to the horizontal position, comprising:
a carriage;
a rod mounted to the carriage;
an arm mounted between the carriage and an underside of the conveyor; and
a motor energizable to extend the rod from a housing and move the carriage and arm in a first direction to raise the conveyor; and
a second actuator assembly for raising and lowering the tray carriage between the raised, horizontal position and the nested position, respectively.

18. The system of claim 13, further comprising:
a delivery system for induction of product to the tray; and
a controller coordinating movement of the delivery system to induct product into the tray when the tray carriage is in the raised, horizontal position or the conveyor is in the incline position.

19. A method of stacking product in either a horizontal orientation or a vertical orientation, comprising:
determining whether product is to be stacked in the horizontal orientation or the vertical orientation;
if stacking is to be in the horizontal orientation:
elevating a tray into a raised, horizontal position;
inducting the product into the tray; and
lowering the tray when the product within the tray meets a predetermined criteria; and
if stacking is to be in the vertical orientation:
rotating a tray into a raised, incline position;
inducting product into the tray; and
lowering the tray when the product within the tray meets the predetermined criteria.

20. The method of claim 19, further comprising:
registering the tray onto a tray carriage and raising the tray carriage in order to elevate the tray;
pivoting a conveyor in order to rotate the tray; and
raising a stop mechanism prior to the rotating step.

21. The method of claim 19, wherein the predetermined criteria is sensing a weight or a height of the product in the tray prior to the lowering steps.

22. The method of claim 19, wherein the product is mail pieces.

23. The method of claim 19, wherein the product is stacked into the tray in a sequenced order.
